(19) United States
(12) Patent Application Publication
(10) Pub. No.: US 2016/0042141 A1
(43) Pub. Date: Feb. 11, 2016

(54) INTEGRATED ASSESSMENT OF NEEDS IN CARE MANAGEMENT

(71) Applicant: International Business Machines Corporation, Armonk, NY (US)

(72) Inventors: Léa Deleris, Dublin (IE); Pol Mac Aonghusa, Kildare (IE); Robert Shorten, Dublin (IE)

(21) Appl. No.: 14/455,511

(22) Filed: Aug. 8, 2014

(51) Int. Cl. G06F 19/00

(52) U.S. Cl. CPC G06F 19/3431

(57) ABSTRACT

A method for a vulnerability analysis application is described. The method includes assembling a profile from a first vulnerability factor grouping from plurality of vulnerability factors with each vulnerability factor having a vulnerability factor value. The method also includes performing a probabilistic operation on the vulnerability factor values from the first vulnerability factor grouping to obtain a first probabilistic result. The method also includes performing a dynamic operation on the first probabilistic result from the probabilistic operation to obtain a first time to vulnerable state for the profile. The method also includes displaying the first time to vulnerable state for the profile.

### BACKGROUND

The present disclosure relates to methods of data analysis, and more specifically, to integrated multi-dimensional assessment of needs through data analysis.

Vast amounts of data are readily and often instantly available, through Internet-sourced public information, direct requests or various other methods. The data cover many aspects of a target individual or that target individual's life. Some of the target individualized data may appear unrelated to other data regarding the same target individual. However, if the apparently unrelated data are properly analyzed, various inferences may be drawn.

### SUMMARY

Embodiments of the present disclosure provide for a method, system and computer program product for integrated assessment of needs in care management through vulnerabilities indexes.

One embodiment is directed toward a method for a vulnerability analysis application. The method includes assembling a profile from a first vulnerability factor grouping from a plurality of vulnerability factors with each vulnerability factor having a vulnerability factor value. The method also includes performing a probabilistic operation on the vulnerability factor values from the first vulnerability factor grouping to obtain a first probabilistic result. The method also includes performing a dynamic operation on the first probabilistic result from the probabilistic operation to obtain a first time to vulnerable state for the profile. The method also includes displaying the first time to vulnerable state for the profile.

Another embodiment is directed toward a system for analyzing behavior. The system includes one or more computer processor circuits that are configured to host a vulnerability analysis application. The vulnerability analysis application is configured to assemble a profile from a first vulnerability factor grouping from plurality of vulnerability factors with each vulnerability factor having a vulnerability factor value. The vulnerability analysis application is also configured to perform a probabilistic operation on the vulnerability factor values from the first vulnerability factor grouping to obtain a first probabilistic result. The vulnerability analysis application is also configured to perform a dynamic operation on the first probabilistic result from the probabilistic operation to obtain a first time to vulnerable state for the profile. The vulnerability analysis application is also configured to display the first time to vulnerable state for the profile.

Another embodiment is directed toward a computer program product for vulnerability analysis including a computer readable storage device having a computer readable program stored therein. The computer readable program, when executed on a computing device, causes the computing device to assemble a profile from a first vulnerability factor grouping from plurality of vulnerability factors with each vulnerability factor having a vulnerability factor value. The computer readable program, when executed on a computing device, also causes the computing device to perform a probabilistic operation on the vulnerability factor values from the first vulnerability factor grouping to obtain a first probabilistic result. The computer readable program, when executed on a computing device, also causes the computing device to perform a dynamic operation on the first probabilistic result from the probabilistic operation to obtain a first time to vulnerable state for the profile. The computer readable program, when executed on a computing device, also causes the computing device to display the first time to vulnerable state for the profile.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a block diagram of an application that is configured to analyze various vulnerability factors for a target profile and produce a time to a vulnerable state for the target profile, according to various embodiments.

FIG. 2 illustrates a dashboard, according to various embodiments.

FIG. 3 illustrates examples of inputs interfaces of current state and factors, and a dashboard display of results, according to various embodiments

FIG. 4 illustrates sample dashboard views of estimated times to vulnerability, according to various embodiments.

FIG. 5 illustrates a flowchart of a method for analyzing vulnerability factors, according to various embodiments.

FIG. 6 illustrates block diagram of a vulnerability engine, according to various embodiments.

FIG. 7 illustrates a flowchart of a method for determining contributing factors in an application, according to various embodiments.

FIG. 8 illustrates a flowchart of a method for determining informative factors in an application, according to various embodiments.

FIG. 9 illustrates a block diagram of automated computing machinery, according to various embodiments.

While the embodiments are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to vulnerability analysis or assessment of needs in care management. Vulnerability factors may be analyzed in order to create a target individual-specific model for vulnerability analysis in terms of various areas of concern. More particular aspects relate to utilizing one or more operations, for example, probabilistic operations, dynamic operations, or other operations to process or analyze various input vulnerability factors. The input vulnerability factors may be made interdependent, with interactions being among various vulnerabilities. A vulnerability engine may communicate various outputs as a vulnerability dashboard. The outputs may be in terms of a single metric and may allow for imprecision through ranges of possible values. A target individual may be identified who presents a multiplicity of problems. While the present disclosure is not necessarily limited to such applications, various aspects of the disclosure may be appreciated through a discussion of various examples using this context.

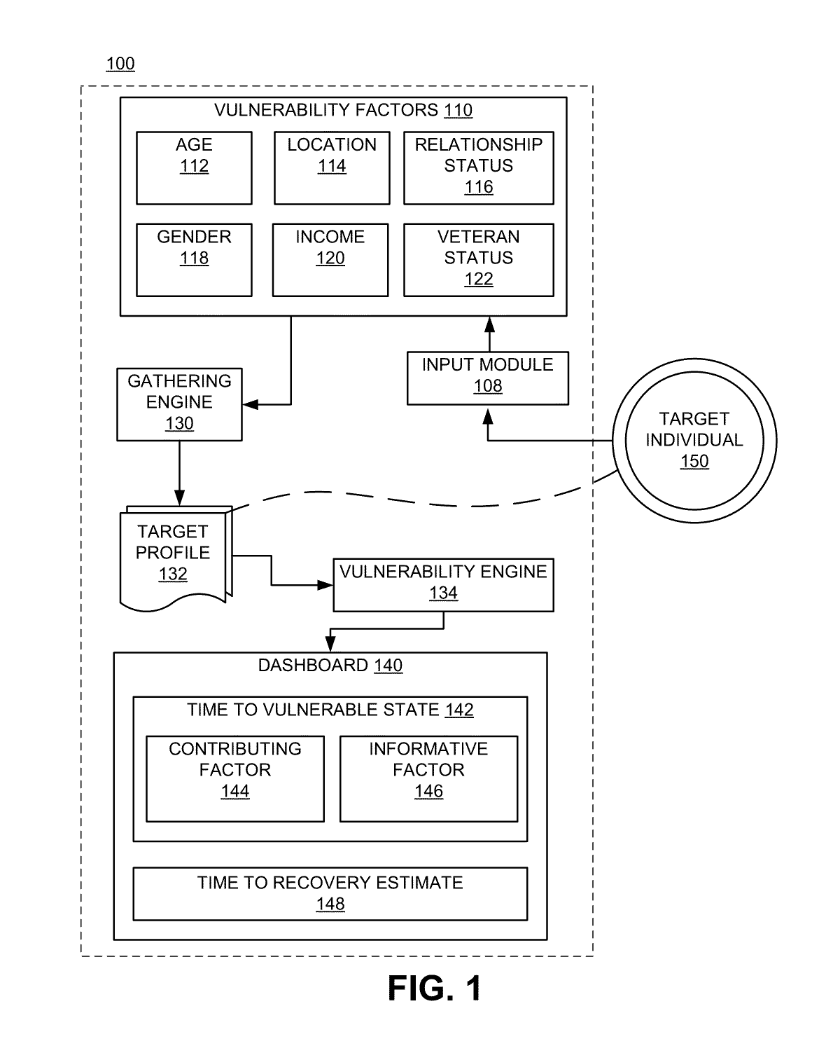

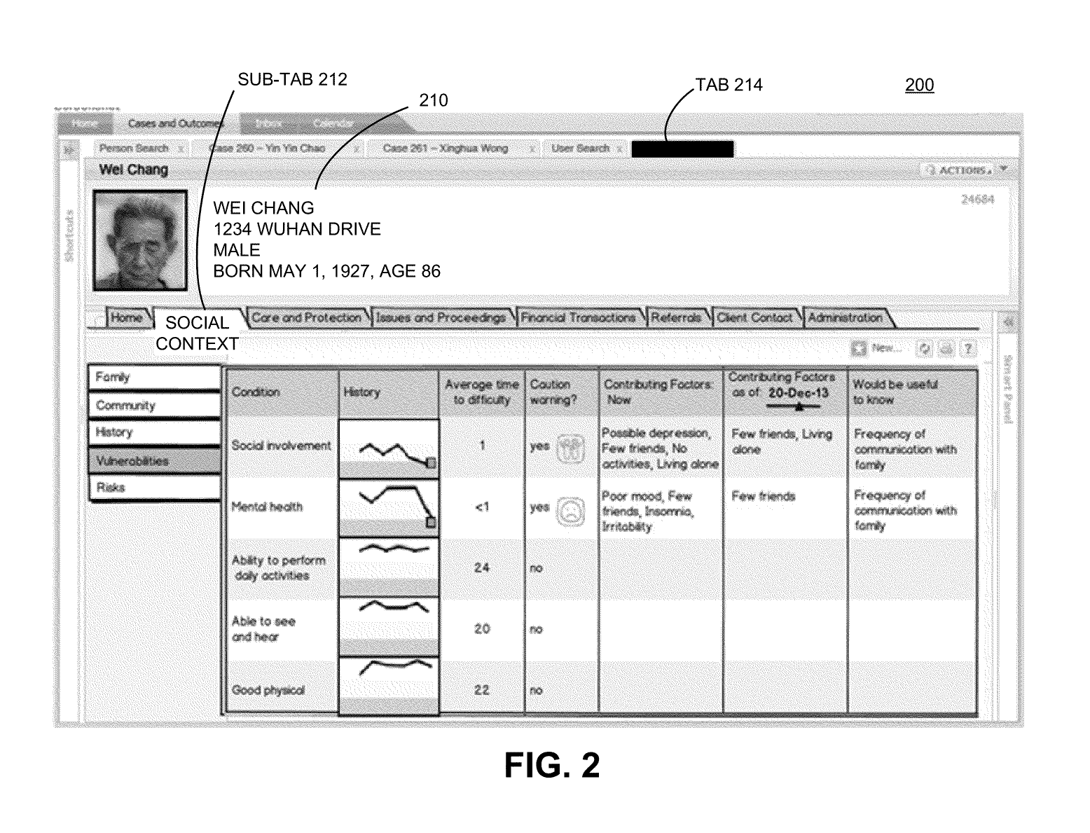

FIG. 1 illustrates a block diagram of an application 100 that is configured to analyze behavior through a grouping of various vulnerability factors 110 of a target individual 150 for a target profile 132 and produce a time to a vulnerable state 142 range (or point estimate) for the target individual's 150 target profile 132, according to various embodiments. Application 100 may evaluate target individual 150. For example, the target individual 150 may be a client of a care worker. The application 100 shows diagrammatically how the grouping of vulnerability factors 110 may be collected, analyzed, and a result displayed on a dashboard 140. FIGS. 2-4, further described herein, represent several possible embodiments of dashboard 140. Vulnerability factors 110 may include numerical values pertaining to a target individual's 150 personal information. Groupings of vulnerability factors 110 may be partial or incomplete as inputs and application 100 may nevertheless produce a dashboard 140. Time to vulnerable state 142 or ranges thereof may be utilized as a single output metric in order to output a comprehensible or understandable dashboard 140.

The application 100 may include an input module 108. For example, an input module 108 may be utilized by a care worker. A care worker is a possible class of user. The care worker may enter various inputs in input module 108 through an interface into a computer program, which may be run on a workstation. At 110, vulnerability factors represented by application 100 may be input. The receipt of the grouping of vulnerability factors 110 and associated data through input module 108 may be accomplished in various ways. As the various vulnerability factors 110 are to be computed in various forms throughout application 100, the vulnerability factors 110 generally are measurable, definable or otherwise analyzable.

The application 100 may include a gathering engine 130. The gathering engine 130 may receive one or more vulnerability factors 110 in a grouping of vulnerability factors. The gathering engine 130 may utilize various Internet website database searches or linked data regarding the target individual 150 in question. The gathering engine 130 may be used as a starting point or to bolster any input data collection about the target individual 150. The gathering engine 130, before a user has entered data into fields, may prefill various vulnerability factors fields, according to various embodiments. Example sites for such searches may include, but are not limited to, Internet web search engines, social networking websites, personal websites, professional websites, and public record databases. Relevant analysis may be done with the help of a computer, as is described in further detail elsewhere herein.

The vulnerability factors' 110 values relate to or are indicative of a particular vulnerability quality of a particular target individual 150. For example, age 112, which is not necessarily a binary query, may generally be answered with a non-negative number. For example, a target individual 150 may be fifty-five years old. Ages of target individuals may be divided into a discrete number of subgroups, for example, ages 50-69 years, 70-89 years, 90 years or greater, etc. The number of subgroups may be large or small, according to various embodiments. At 112, for example, age may be answered simply ‘old’ or ‘young’ or with a decimal value, for example ‘36.23 years.’

Other vulnerability factors 110, for example, relationship status 116, may have a discrete number of defined categories into which a target individual may fall. Regardless of the number of categories from which answers are chosen, there may be some discrete number of choices, for example, single, married, and divorced would represent three discrete choices. Additionally, vulnerability factors 110, individually or in a grouping, may variously be represented or stored through use of computer-readable mediums, according to various embodiments.

The gathering engine 130 may receive a grouping of various vulnerability factors 110 through input module 108, as is outlined herein. The gathering engine 130 may then compile the input vulnerability factors 110. The input grouping of vulnerability factors 110 may take the form of a data structure. A data structure may include databases or other computer-readable formats, for example, comma separated values (‘CSV’), extensible mark-up language (‘XML’), JavaScript Object Notation (‘JSON’), or IBM® DB2® values, etc. Associated databases may be variously structured or semi-structured. Various forms of data structures may exist. For example, a structured query language (‘SQL’) database may be utilized. The SQL database may be keyed to a target individual's 150 profile. For example, the target individual 150 could correspondingly act as the primary key of the SQL database.

Any available data regarding the vulnerability factors 110, as received by gathering engine 130, may be contained in a database. The gathering engine 130 may compile the various inputs, assembling a customized target profile 132. Target profile 132 may contain any available data about the target individual 150, in a database or other computer readable format. FIG. 1 represents this connection with a dashed line connecting the target individual 150 and his or her target profile 132.

The target profile may serve as a single-location repository for any available data about the target individual 150 for which analysis is desired. By locating all available data about the target individual 150 in a single centralized location, a process may be able to read relevant data and produce an output in a timely manner. Additionally, by locating relevant data in one single location or repository, any changes may be made at a single centralized location, eliminating a potential need to search for data in multiple locations. According to various embodiments, available data may be located or stored in multiple locations.

After the target individual-specific target profile 132 has been created, the target profile 132 may then be processed or analyzed by vulnerability engine 134. Output dashboard 140 may be composed through analysis of a target individual's 150 inputted data, and the dashboard 140 may therefore be unique to the target individual 150 and the target individual's 150 associated data.

For the purposes of analysis, multiple distinct dimensions of vulnerabilities across various categories may also interact through analytic interdependence. Example interactions may utilize social factors, health or social vulnerabilities. At 134, the vulnerability engine's underlying analytic models may be created from a number of data sources. For example, population studies, experts' opinions, or census (i.e., aggregated) information may be composed and utilized. The analytics model underlying the vulnerability engine 134 may be built off-line. When used for vulnerability evaluation, the target profile may be used as an input query for the vulnerability engine, which then may output various vulnerability indicators in the form, for example of time, to vulnerable state to the dashboard 140.

Vulnerability analysis, through the vulnerability engine's interdependent analysis of various vulnerability factors 110 leading to multiple vulnerability indexes presented in the dashboard 140 may be useful to identify target individuals having a multiplicity of problems. If the target individual is a client of a care worker, the client may be identified as a client who needs to be handled, treated or analyzed differently than the majority of clients. This client may be identified as a ‘High-Cost, High-Need’ category client. High-Cost, High-Need clients' status may be displayed or communicated to a user, or may be stored for later use, according to various embodiments. The vulnerability engine may treat High-Cost, High-Need clients different than other clients. For example, the vulnerability engine may weight factors for analysis differently or use different formulas than for other clients, according to various embodiments.

After the processing and analysis are completed, the vulnerability engine 134 may output a dashboard 140 displaying a plurality of visual representations of data. In application 100, for example, there are two dashboard 140 outputs depicted. Dashboard 140 outputs include time to vulnerable state 142 and time to recovery estimate 148. Time to vulnerable state 142 may be a numerical value and may be measured in units of time. Time to vulnerable state 142 may also include or display uncertainties in the calculated estimate of time. The uncertainties may follow from partial, incomplete or lacking data compiled at an earlier stage, for example. A particularly secretive or private target individual 150, for example, may be reticent to disclose relevant personal data. The target individual's 150 reticence may lead to substantial uncertainties in displayed dashboard 140 results. An estimated time to vulnerable state 142 range may still be displayed on dashboard 140 based on the details the target individual 150 provided (or other sources of information, as described herein).

A time to vulnerable state 142 or a range thereof may be an indication of an estimated time that would elapse before a target individual 150 is predicted to be exposed to a particular vulnerability, for example, unemployment. At time to vulnerable state 142, estimated times to vulnerability state, as defined by vulnerability factor 110 inputs, may be measured with a single metric. For example, as shown in application 100, time to vulnerable state 142 utilizes time as a single principal unit by which measurements and comparisons may be made. The single metric may allow an isolated variable output. This may in turn allow for efficient or understandable comparison across a target individual's 150 multiple vulnerability factors 110 or times to vulnerable state 142, or alternatively multiple target individuals on a single vulnerability factor 110 or time to vulnerable state 142.

When vulnerability engine 134 has output a time to vulnerable state 142, further information may be provided regarding a target individual 150. Time to vulnerable state 142 may further include identification of one or more contributing factors 144 or one or more informative factors 146. The dashboard 140 may display relevant information regarding contributing factors 144, including which specific factors (among the set of vulnerability factors) were particularly influential upon the output time to vulnerable state 142. Relevant information displayed may include details relating to interdependent vulnerabilities and the effects cause by the interdependence, if any. At dashboard 140, relevant information regarding informative factors 146 may be displayed including which particular factors (among the set of vulnerability factors), if changed, would be particularly influential upon the time to vulnerable state 142, and possibly if the target individual 150 could become identified as High-Cost, High-Need, depending on the target individual's grouping of various vulnerability factors 110.

Various metrics may be implemented to isolate which vulnerability factor 110 inputs are influential as contributing factors 144. Influential vulnerability factor 110 inputs, for example, may be inputs that yield the largest or most significant change as a result of change for one or more contributing factors 144, or which vulnerability factor 110 values would be most influential (i.e., largest potential change in various dashboard 140 outputs as a result) for one or more informative factors 146. The most influential potential change may be measured in various ways. For example, for a given question, the most influential change may be the average change over all possibilities or the largest range of change for one response to another, among others.

A contributing factor 144 may help describe the time to vulnerable state 142 and range thereof, as displayed on the dashboard 140. To output a contributing factor 144, the vulnerability engine 134 may systematically take the time to vulnerable state 142 and break it down deconstruct it analytically in order to find the principal factors that led to the time to vulnerable state 142. The vulnerability engine 134 may also determine whether a target individual, such as a client of a care worker, is identified as High-Cost, High-Need, and that status may be displayed on dashboard 140. For example, if a target individual's 150 particular time to vulnerable state for homelessness is under two years, a dashboard 140 may indicate that the target individual's state of unemployment has had a noted impact on the target individual's 150 estimated time to vulnerable state 142 (for lack of shelter). The vulnerability engine 134 may likewise indicate on dashboard 140 that a newly secured basic minimum wage job, compared to no job, may increase the target individual's 150 estimated time to vulnerable state 142 (for lack of shelter) to four years, or a doubling of the estimated time to vulnerable state 142.

An informative factor 146 may help predict the time to vulnerable state 142. To output an informative factor 146, the vulnerability engine 134 may analyze possible changes to current data gathered by gathering engine 130 into target profile 132 by taking changed outputs and tracing the outputs to what vulnerability factors 110 could have led to comparable outputs. Utilizing the vulnerability engine 134, crucial potential queries may be discovered by inputting times to vulnerability state 142 and outputting crucial vulnerability factor 110 inputs.

For example, the vulnerability engine 134 may take changed outputs and trace the outputs, using a combination of probabilistic and dynamic operations to find what vulnerability factors 110 and what types of answers could have led to comparable outputs. The crucial queries may then be converted into guidance for a care worker, according to various embodiments. For example, the care worker may be guided to ask the most salient and relevant questions of or regarding the care worker's client.

Regarding direct questions asked the client, there are at least two relevant aspects. In some cases a question may not have yet been asked or answered at all. In other cases a question may have been answered, but a change in the answer may be possible. For example, if a client (i.e., a target individual 150) had recently moved from a statistically high crime area to an area with statistically low crime, various estimated times to vulnerable state 142 may be critically disadvantaged or benefited by such a change in the client's geographic location. The location could have recently changed. Additionally, a client's embarrassment, truthfulness and thoroughness may have an effect on the answers given therefrom.

In other cases, information regarding vulnerability factors 110 may have been gathered without direct contact or solicitation from a target individual 150. Research may have been conducted regarding the target individual 150, but the accuracy of this research may be subject to uncertainty. It may be advisable for the target individual 150 be asked directly to confirm if certain information is accurate. For example, in the case of a care worker analyzing a client, background searches may find public records indicating a place of residence. However, the client's place of residence may be subject to change without immediate updates to the various databases used to find this information. In certain cases, to reduce uncertainty a care worker may directly ask the client where he or she currently resides.

For certain target individuals, current needs may exist, from which there may be estimated times to recovery. Vulnerability engine 134 may display on dashboard a time to recovery estimate 148. If a target individual has current needs and is currently in a vulnerable state, then a separate calculation may be used to estimate how much time is likely to pass before the target individual 150 regains a state of non-vulnerability (i.e., no longer is in a vulnerable state). Another possible way of describing the time to recovery estimate is that of a ‘severity’ index. In other words, how dire is the situation in which the target individual 150 finds him or herself. For example, if a target individual 150 is currently unemployed, there is a time to vulnerable state 142 (unemployed) of zero, as the target individual 150 is already in the vulnerable state. There is no associated range of times to vulnerable state 142 in this case. However, this target individual 150 may become employed in the near or distant future. The severity index may be a factor contributing to whether the target individual is identified as High-Cost, High-Need. Various factors play into continued states of vulnerability, and may have an effect on how long this target individual 150 stays in a particular vulnerable state. For example, if a target individual 150 has stable shelter and is married, the vulnerability engine 134 may combine and process the two possibly interdependent factors. For example, the vulnerability engine 134 may estimate that this target individual 150 has a time to recovery estimate 148 of six months. However, if the target individual 150 lives in a poor neighborhood (i.e., location 114), has veteran status 122 and is a woman (i.e., gender 118), the vulnerability engine 134 may find that the time to recovery estimate 148 relating to unemployment rises to approximately three years. A target individual, if identified as a High-Cost, High-Need category target individual, may receive specialized treatment by the vulnerability engine 134.

FIG. 2 illustrates a dashboard 200, according to various embodiments. For example, the dashboard 200 could be an example of dashboard 140 as described and shown in FIG. 1. This example embodiment may relate to care workers or tools to guide questioning of a client (i.e., a target individual 150). The dashboard 200 may include a tab 214 for Wei Chang, a hypothetical client being profiled.

At a section 210, the target individual's known photo, address, gender and date of birth may be displayed. In this example, the client is Wei Chang, and his name, address, gender and date of birth are displayed.

Within tab 214, there may be various sub-tabs, such as sub-tab 212, which is labeled ‘Social Context.’ The Social Context tab 212 example, may further contain various other details about the target individual. For example, categories such as ‘Family,’ ‘Community,’ ‘History,’ ‘Vulnerabilities’ and ‘Risks’ may be displayed. A vulnerabilities category may further contain more detail. Examples of details may include ‘Condition,’ ‘History,’, corresponding to historical values of 142; ‘Average time to difficulty,’ corresponding to time to vulnerable state 142; ‘Caution warning,’ corresponding to alerts to the care workers; ‘Contributing factors now, corresponding to contributing factors 144’; ‘Contributing factors as of a previous date,’ corresponding to historical values for 144, and ‘Would be useful to know,’ corresponding to informative factors 146. Displayed details within Social Context tab 212 may take various forms, such as text, numbers, graphical representations, etc.

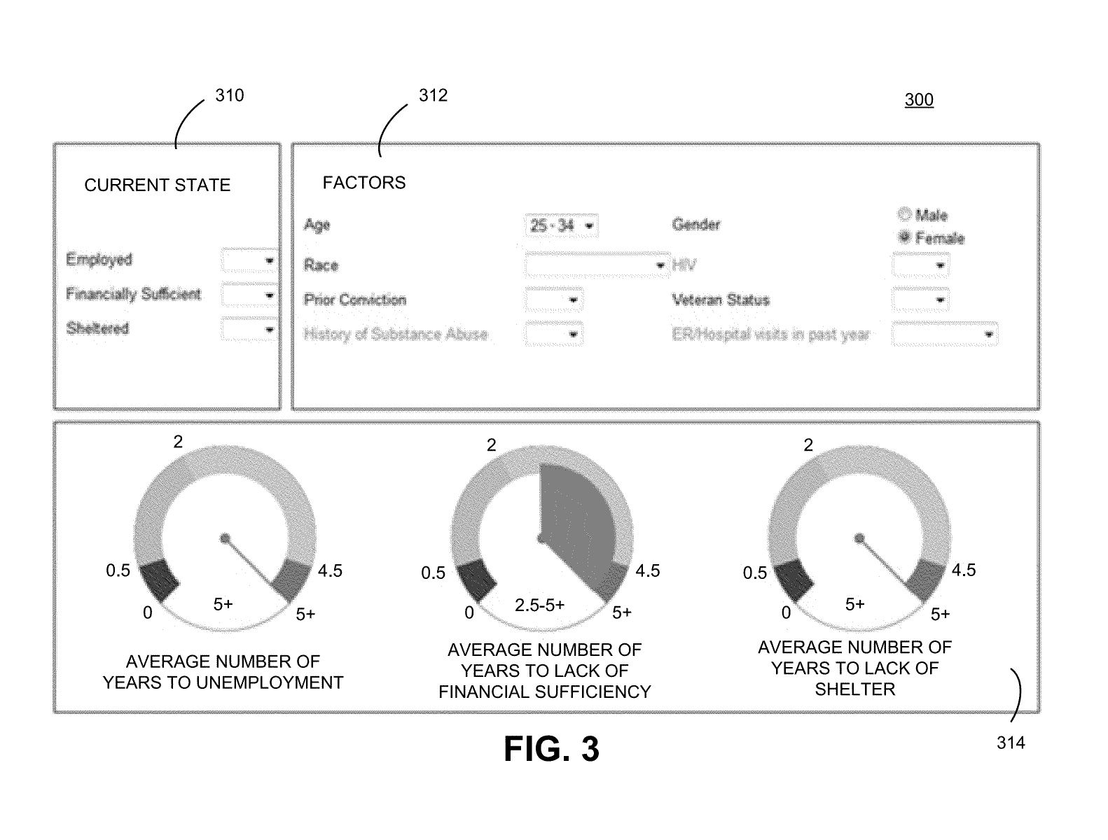

FIG. 3 illustrates an example of an input module 300, according to various embodiments. The input module 300 may correspond to input module 108 from FIG. 1. The input module 300 contains input interfaces for current state 310 and factors 312. A care worker may use input interfaces 310 and 312, according to various embodiments. Factors 312 represent examples of various vulnerability factors 110 as shown in FIG. 1. Also shown is an output dashboard display (140 in FIG. 1) of results 314 as may be seen by a care worker, according to various embodiments.

A current state input interface 310 enables input of various data, which may relate to the target individual's current state, according to various embodiments. Examples shown are questions such as ‘Employed,’ ‘Financially Sufficient,’ and ‘Sheltered.’ A care worker, for example, may enter known answers into the current state input interface 310. The current state inputs 310 may be a current assessment on similar dimensions to those output in terms of estimated times to vulnerability at a later stage.

Various vulnerability factors 110, here divided into current state 310 and factors 312, may represent any inputs received relating to a target individual 150 for which an analysis is desired and may represent one or more identified measurable factors tied to the particular target individual 150. Examples of various vulnerability factors 110 may include age, location, relationship status, gender, income or veteran status, as is described elsewhere herein. Vulnerability factors may be represented by various forms of data. For example, ‘yes or no’ answers, or numerical answers may be appropriate to satisfy vulnerability factor questions, according to various embodiments.

A factors input interface 312 may represent more detailed questions of the target individual in question, according to various embodiments. Examples of questions may include ‘Age,’ ‘Race,’ ‘Prior Conviction,’ ‘History of Substance Abuse,’ ‘Gender,’ ‘HIV,’ ‘Veteran Status,’ or ‘ER/Hospital visits in past year.’ Questions may be either answered or left unanswered, depending on the situation and what information is known or able to be found.

A dashboard display of estimated times to vulnerability 314 in this example represents a possible visual representation of estimated times to vulnerability in terms of various dimensions. At 310, the current state input interface contains three categories, and the dashboard contains the same three categories, according to various embodiments. In having similar dimensions for the current and future, comparisons may be made more relevant or insightful, according to various embodiments.

The dashboard 300 may display various expected times to vulnerability states 314 for a target individual. For example, expected time to unemployment, lack of financial sufficiency or lack of shelter. The resulting expected time values, as displayed on dashboard 300, may contain imprecision ranges to allow for extrapolation of relatively incomplete vulnerability factor data including current state 310 and factors 312 gathered by gathering engine. For example, if an expected time to vulnerable state is great, it may be represented as ‘five or more years’ or ‘5+(years),’ potentially adding to understandability or clarity of data displayed in example dashboard 300, according to various embodiments.

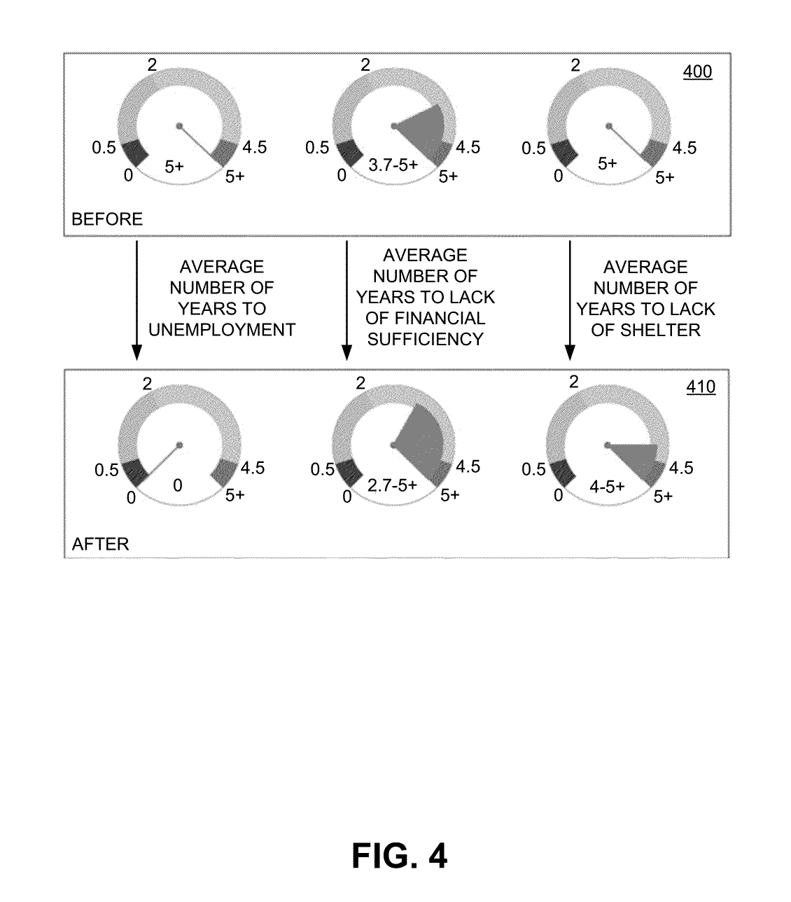

FIG. 4 illustrates two example dashboard displays of estimated times to vulnerability (before) 400 and (after) 410. One or more changes to a target individual's situation may have an impact on the dashboard's estimated times to vulnerability. Estimates times to vulnerability (before) 400 may display on a dashboard a target individual's estimated times to vulnerability before the target individual's job was lost.

Estimated times to vulnerability (after) 410 may display updated times to vulnerability for the target individual after that target individual's job loss or change in unemployment status. Estimated time to unemployment now displays a zero as the target individual is currently unemployed.

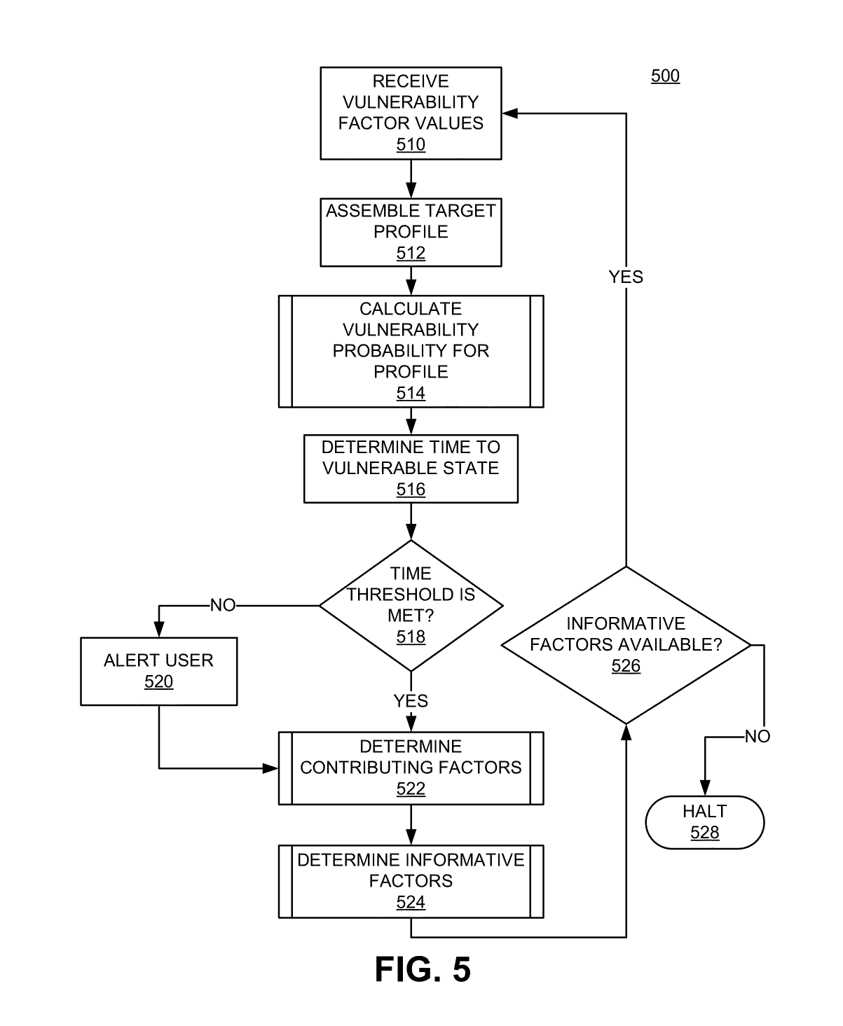

FIG. 5 illustrates a flowchart of a method 500 for analyzing vulnerability factors, according to various embodiments. A possible usage of the method 500 may be in a care setting. In a care setting the method 500 may be a vulnerability engine configured to alert a user, for example a care worker, to a possible vulnerability of a target individual being examined. The alert may take various forms. A user may be a person who is responsible for monitoring the well-being of a target individual. The user may be a care worker, according to various embodiments.

In method 500, an input module may receive a target individual's vulnerability factor values at operation 510. The input module may receive the target individual's vulnerability factor values through various inputs, such as an input module or a user interface, according to various embodiments. According to various embodiments, target individual's various vulnerability factor values may be known or ascertained.

The gathering engine may assemble a target profile from vulnerability factors at operation 512. The target profile may be specific to the target individual, as described herein. The target individual's unique data may be used to compose the profile. The profile may take various forms, such as various databases. The target individual's data may be organized in various ways. For example, the target individual's data may be organized in terms of related vulnerability factors.

At operation 514, the vulnerability engine may calculate various vulnerability probabilities for the profile, according to various embodiments. The probabilities may be calculated by various means, as is described elsewhere herein. The vulnerability engine may utilize probabilistic static or dynamic operations may be used to perform various analytic calculations. The vulnerability engine may analyze the target profile, assembled at operation 512, using the probabilistic or dynamic operations. A probabilistic operation may output a probabilistic result. A dynamic operation may then be performed on the probabilistic result. Examples of probabilistic operations may include statistical modeling such as regression but also risk inference from probabilistic model such as Bayesian networks, according to various embodiments. Examples of dynamic operations may include computation of mean first passage time in Markov chains models, according to various embodiments. The operations may utilize stored data and the stored data may be organized in various ways. For example, the stored data may be organized in the form of a database. Various data may then be selected from the database and the various probabilistic or dynamic operations may be performed thereto.

At operation 516, the vulnerability engine may determine a time to vulnerable state using the calculated vulnerability probability for the profile at operation 514. The calculations and probabilities from operation 514 may produce a result in the form of a single metric. The single metric may be time to vulnerable state for the target individual, according to various embodiments. By producing one or more results in terms of a single metric, the results may be more easily understood or analyzed. Regarding analysis, a single metric result may allow for efficient comparisons between multiple target individuals on one vulnerability factor value, or between multiple vulnerability factors values for one target individual. For example, for a particular target individual, the target individual may have a target profile containing several answered vulnerability factors. The vulnerability factor values answered may include age (e.g., 67.23 years of age), gender (e.g., female), and veteran status (e.g., is a veteran). The average number of years to vulnerability may now be determined at operation 516. For example, the average number of years to lack of shelter may be found to be 4.25 years. For another example, the average number of years to unemployment may be found to be 0.50 years. For yet another example, the average number of years to lack of financial sufficiency may be found to be ten years, which may be classified as ‘five or more years,’ according to various embodiments.

At operation 518, the vulnerability engine receives a time to vulnerable state threshold, and the vulnerability engine compares the determined time to vulnerable state at operation 516 to the vulnerable state threshold. The time to vulnerable state threshold may be a defined specific time to vulnerable state. The time to vulnerable state threshold may be defined by a user, for example, a care worker, according to various embodiments. The time to vulnerable state threshold may also be received from a computer or computer program or database, according to various embodiments. A time to vulnerable state threshold may be met if a calculated time to vulnerable state is less than or equal the amount of time for the particular threshold. If there is a range of estimated times to vulnerable state, the maximum of the range, the median of the range, or the mean of the range may be utilized, among other measurements to determine whether the threshold has been met, according to various embodiments.

Examples of time to vulnerable state thresholds may include a set amount of time over all vulnerabilities, for example, five years to vulnerable state. If the threshold is set to five years, then if a determined time to vulnerable state is three years for any one vulnerability, then the threshold will be met. In another example, the threshold may be set so that any particular vulnerability, such as lack of shelter or unemployment, when reaches a time to vulnerable state may meet the defined threshold for that particular vulnerability. For example, the threshold for lack of financial sufficiency may be set to ten years. If the target individual has a time to vulnerable state of lack of shelter of five years, this would not meet this particular threshold, though it may meet another threshold, according to various embodiments.

At operation 520, if the threshold is not met for a time to vulnerable state at operation 518, a user may be alerted. The user may include, but is not limited to, a care worker. The alert at operation 520 may take various forms, according to various embodiments. One possible form of the alert may be through a software application used by the user. The user may receive the alert in various forms. An alert may include a sound, a pop-up message, an email, a short message service (‘SMS’ or text) message, a flashing light, force or haptic feedback, electric impulse, etc. Alerts may be classified, for example according to severity or urgency. For example, there may be a plurality of thresholds for any particular vulnerability. Each threshold may be assigned a level of severity or urgency, and alerts to user may indicate the severity or urgency of the alert, according to various embodiments. Based on the severity or urgency of the various alerts, different methods of alerts may be used. For instance, an email may be used for a low severity threshold that is met, but a high severity threshold if met may utilize force feedback to alert the user. Additionally, a target individual may be identified as being a High-Cost, High-Need category. If the target individual is identified as High-Cost, High-Need, then alert thresholds or alert urgencies may be varied, according to various embodiments. However, if the threshold is met for a time to vulnerable state at operation 518, then the user may not be alerted by the application, and operation 522 may proceed.

At operation 522, the vulnerability engine may determine contributing factors. The vulnerability engine may determine contributing factors by analyzing various times to vulnerable state. By analyzing times to vulnerable state the vulnerability engine may determine which vulnerability factors contributed most to the time to vulnerable state. When a contributing factor is identified, a record of the identified factors may be input in computer-based medium, such as a workstation. The identified factors may be stored and organized in various ways. Various forms of storage or organization may include the use of databases. Aspects of operation 522 may be further described herein.

At operation 524, the vulnerability engine may determine informative factors after contributing factors have been determined at operation 522. By analyzing times to vulnerable state and potential times to vulnerable state with changed vulnerability factors, the vulnerability engine may determine which vulnerability factors and vulnerability factor values would contribute substantially if their values were to change. Taking a first grouping of vulnerability factors and changing one or more vulnerability factors may create a new grouping of vulnerability factors. When an informative factor is identified, a record of the identified factors may be input to computer-based medium, such as a workstation. The identified factors may be stored and organized in various ways. Various forms of storage or organization may include the use of databases. Aspects of operation 524 may be further described herein

At operation 526, a user may receive identified informative factors, determined at operation 524, displayed on a dashboard, such as on a workstation. The user, who may be a care worker, may use knowledge of various informative and contributing factors to direct questions to the target individual, who may be a client of the care worker. The user may use knowledge that changes to various informative or contributing factors, whether previously answered or not, could have a substantial effect on the target individual's time to vulnerable state. If the application or the user determines that no informative factors are available at operation 526, then the method 500 may halt.

Any determined contributing factors, informative factors or alerts may be displayed. The display may take the form of a dashboard. The dashboard may be displayed on a user's workstation, or on a target individual's personal computer, smartphone or other device, according to various embodiments. If the process halts, then more vulnerability factors may be awaited, searched or received before assembling a new target profile at operation 512, after which the process then may repeat.

Otherwise, if informative factors are available, the informative factors may be received as vulnerability factor values at operation 510. If revised or new answers to informative factors are received, the method 500 may continue to operation 510 with the new data. The new data may include new vulnerability factors, which may now lead to the alerting of a user at operation 520 if the vulnerability engine 500 determines that the target individual now has a time to vulnerable state that does not meet the threshold, according to various embodiments.

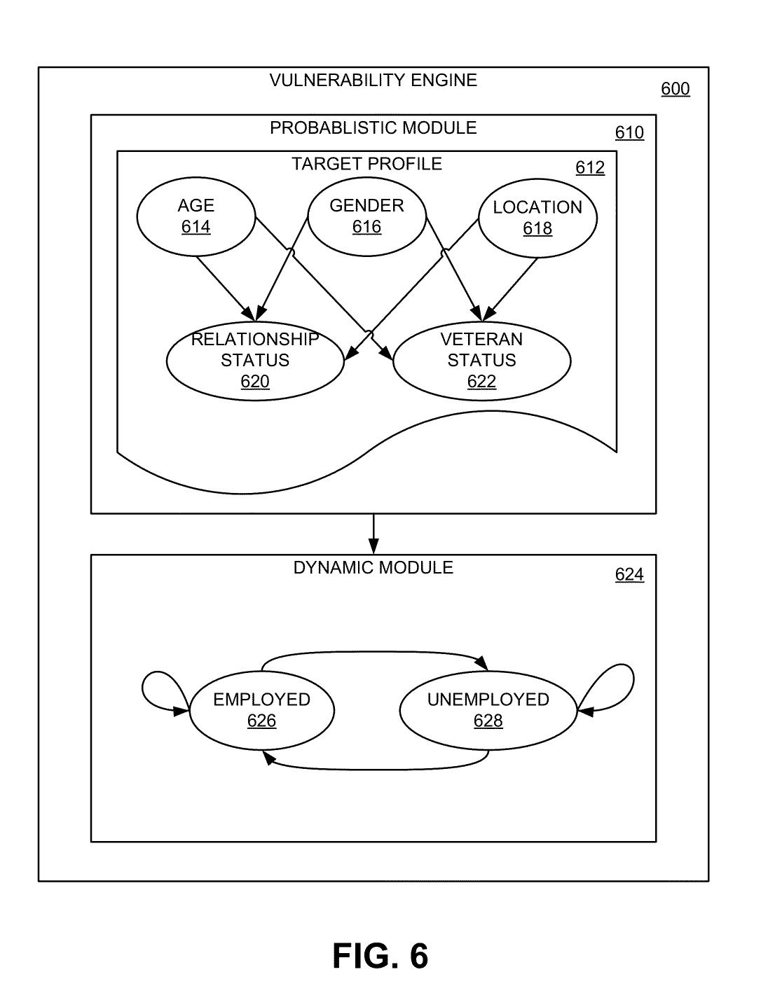

FIG. 6 illustrates a vulnerability engine 600, according to various embodiments. Vulnerability engine 600 may share various elements or characteristics with vulnerability engine 134 in FIG. 1, according to various embodiments. Example vulnerability engine 600 may include a probabilistic module 610 and a dynamic module 624.

Processing in vulnerability engine 600 may be accomplished through use of various computer systems, such as personal computers or various commercial computer systems, for example, workstations or server blades. A database storing and organizing data may feed into a vulnerability engine 600. For example, an SQL database may be input into the vulnerability engine 600. The vulnerability engine 600 may include use of one or more probabilistic models, such as Bayesian networks, as represented by probabilistic module 610.

Probabilistic module 610 may contain a target profile 612. Located within target profile 612 may be a plurality of vulnerability factors. For example, the factors (see FIG. 1, 132) may include age 614, gender 616, location 618, relationship status 620, or veteran status 622. The factors may be related by a probabilistic or Bayesian network. For example, if an target individual's age 614 is young and the target individual's gender 616 is female, both inputs together may make it either more or less likely probabilistically for resulting veteran status 622 to be answered in the affirmative for the target individual. Arrows in target profile 612 pointing from age 614 and gender 616 represent a possible embodiment of a probabilistic operation.

Operations, probabilistic (e.g., Bayesian networks) or dynamic (e.g., Markov chains), may underpin the vulnerability engine 600. In various embodiments, the vulnerability engine 600 may operate using only probabilistic operations, only dynamic operations or both probabilistic and dynamic operations. For example, a probabilistic operation in probabilistic module 610 first may create associations among relevant factors. Following the probabilistic operation, the probabilistic operation outputs may be input into a dynamic operation in dynamic module 624. The dynamic module 624 may complete up-to-date determinations regarding the target individual's expected time to vulnerable state or range thereof. In certain cases, a change may occur regarding one or more vulnerability factors of the target individual's grouping of vulnerability factors. The changes may result from newly-discovered (but possibly pre-existing) information regarding vulnerability factors, or alternatively if a target individual's particular vulnerability factor changes over time. The target individual's grouping of vulnerability factors may then change as various vulnerability factors change.

An example of a newly-discovered, changed vulnerability factor could be if a target individual 150 initially did not report income level, but later acknowledged an income below the poverty line. An example of a vulnerability factor changing over time would be if a target individual, formerly employed, now finds him or herself unemployed after losing a job. For various examples discussed herein, new probabilistic operations may be synthesized in probabilistic module 610 before re-applying a dynamic operation in dynamic module 624 to calculate an updated estimated time to vulnerable state of the target individual, as is explained in further detail elsewhere in this disclosure.

Dynamic module 624 may contain a dynamic operation. For example, a dynamic operation may utilize a Markov chain for various states. For example, dynamic module 624 contains dynamic states ‘employed’ 626 and ‘unemployed’ 628. For example, a target individual is currently employed 626. For a given time in the future, there is a probability that the target individual will remain employed 626. There is also a related complementary probability that the target individual will be unemployed 628 at that time in the future.

For example, at one year in the future, and for all other vulnerability factors known, a probability of remaining employed 626 may be 0.90, leaving a 0.10 probability of unemployment at one year. And, for a target individual who is currently unemployed 628, at one year in the future, and for all other vulnerability factors known, a probability of becoming employed 626 may be 0.80, leaving a 0.20 probability of unemployment at one year. A possible embodiment of a resulting probability matrix is illustrated below:

$$P ( Employment ) at one year = [ \begin{matrix}.90 & .10 \\ .80 & .20\end{matrix} ]$$

Using the above probability matrix, a target individual-specific likelihood of employment one year from now may be calculated, regardless of whether the target individual is currently employed. Similar processes, for example those related to computations of mean first passage time, may be repeated and expanded according to various embodiments. Calculated results may then be displayed on a dashboard, according to various embodiments.

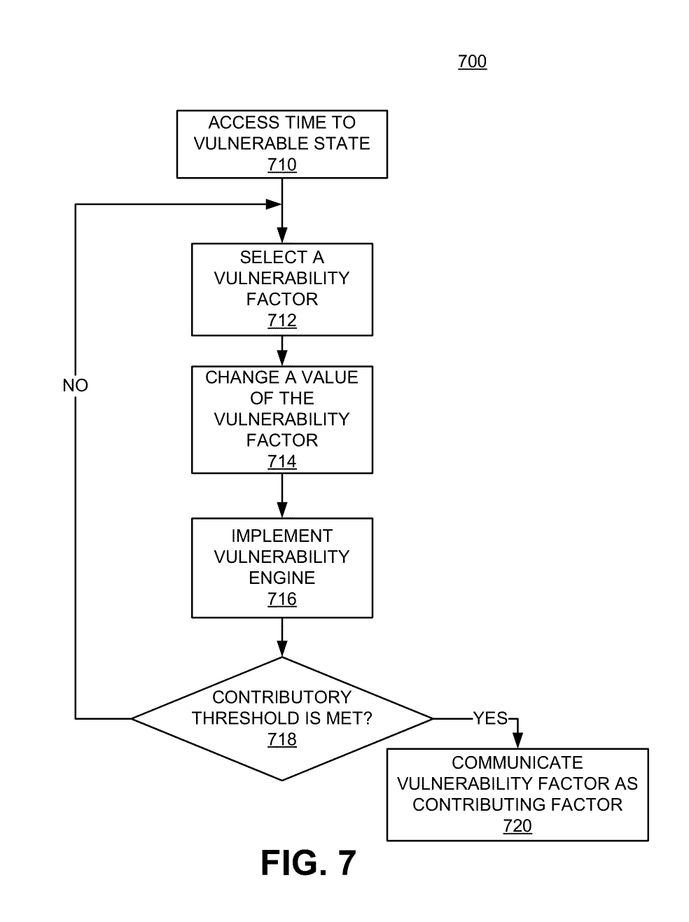

FIG. 7 illustrates a method 700 for determining contributing factors in an application, according to various embodiments. According to various embodiments, method 700 may correspond to operation 522 in FIG. 5. Method 700 may be a vulnerability engine, according to various embodiments.

The vulnerability engine 700 may access time to vulnerable state at operation 710. At operation 710, accessed time to vulnerable state may be a time to vulnerable state, according to various embodiments. Access of time to vulnerable state may occur before an output of time to vulnerable state is displayed.

At operation 712, the vulnerability engine selects a vulnerability factor. The vulnerability engine may select a particular vulnerability factor for various reasons. For instance, the selected vulnerability factor may be generally considered to be influential on output. The vulnerability engine may also select a vulnerability factor at random, according to various embodiments. The vulnerability engine may randomly select a vulnerability factor by various means of randomization or may simply selected the vulnerability factor from a present ordered list of vulnerability factors. For example, some vulnerability factors may generally have a more or less substantial effect on times to vulnerable state and the vulnerability engine may therefore prioritize selection of the vulnerabilities with a generally more substantial effect. Whether the selected vulnerability is selected in particular or at random, the vulnerability engine may select the vulnerability factor to avoid repeating before all vulnerability factors are each selected once, potentially avoiding or reducing redundancy, according to various embodiments.

At operation 714, the vulnerability engine may then change the value of the selected vulnerability factor value. For example, if the vulnerability factor value is currently answered ‘Yes,’ the value may be changed to ‘No.’ For another example, if there are more than two possible values or answers, an answer may be changed numerically, by various amounts, according to various embodiments. For example, if there is a range of possible values or answers, the vulnerability engine may utilize either part of the range or the entire range. For answers that are measurable numerically, this may mean the vulnerability engine may utilize very small or very large answers, according to various embodiments. Finally, another possibility is to set the value to “Unknown,” thus removing it from the target profile.

At operation 716, the vulnerability engine may implement the changed vulnerability factor value from operation 714. The vulnerability engine may calculate a new time to vulnerable state using the changed vulnerability factor value. The estimated time to vulnerable state may be different than the estimated time to vulnerable state before the vulnerability engine changed the vulnerability factor value.

At operation 718, the vulnerability engine's output of the new time to vulnerable state as calculated may be analyzed to determine if the time to vulnerable state meets a contributory threshold. A contributory threshold serves as a level at which the vulnerability engine determines that an isolated vulnerability factor has a substantial impact on a target individual's time to vulnerable state. A contributory threshold is defined by a time to vulnerable state. The contributory threshold may be set by various means. For example, a user may determine and set that a particular threshold is a critical level of a time to vulnerable state. The time to vulnerable state contributory threshold may be set higher or lower for various vulnerability factors. The vulnerability engine, through a database or other computer-stored program may also set one or more contributory thresholds, according to various embodiments. Another example of determining a contributory threshold is to compare the relative difference in value between the original time to vulnerable state and the updated time to vulnerable state. The database or other computer program used to determine a contributory threshold may be particular to various purposes of the user, according to various embodiments. For another example, a target individual may have a determined time to vulnerable state of four years. The vulnerability engine may determine that the target individual's status as a veteran subtracted two years to a time to vulnerable state that would have otherwise been six years. If a contributory threshold were set at one year, the status as a veteran would have met the contributory threshold and the veteran status would be a contributing factor displayed on a dashboard, according to various embodiments.

At operation 720, if the vulnerability engine determines that the contributory threshold is met at operation 718 then the vulnerability engine identifies or communicates the vulnerability factor or the vulnerability factor value as a contributing factor. A dashboard may communicate the contributing factor, according to various embodiments. Otherwise, if the contributory threshold is not met, the vulnerability engine accesses a time to vulnerable state at operation 710 and the vulnerability engine selects another vulnerability factor at operation 712 and the process proceeds for that vulnerability factor.

For example, a target individual may be a client of a care worker. The vulnerability engine or a user may identify a target individual as particularly vulnerable to lack of shelter, indicated by a time to vulnerable state. A dashboard may display contributing factor, which may in turn indicate that vulnerability factor regarding geographic location indicated a particular geographic location that tends to correlate to poor access to affordable housing. Accordingly, the vulnerability factor of shelter may be selected. The care worker may implement a vulnerability engine, and a contributory threshold may be met. The care worker's dashboard may indicate to the client that a change of geographic location may be beneficial for the client, according to various embodiments. At operation 720, this fact may be identified as a contributing factor to the client's time to vulnerable state (for lack of shelter).

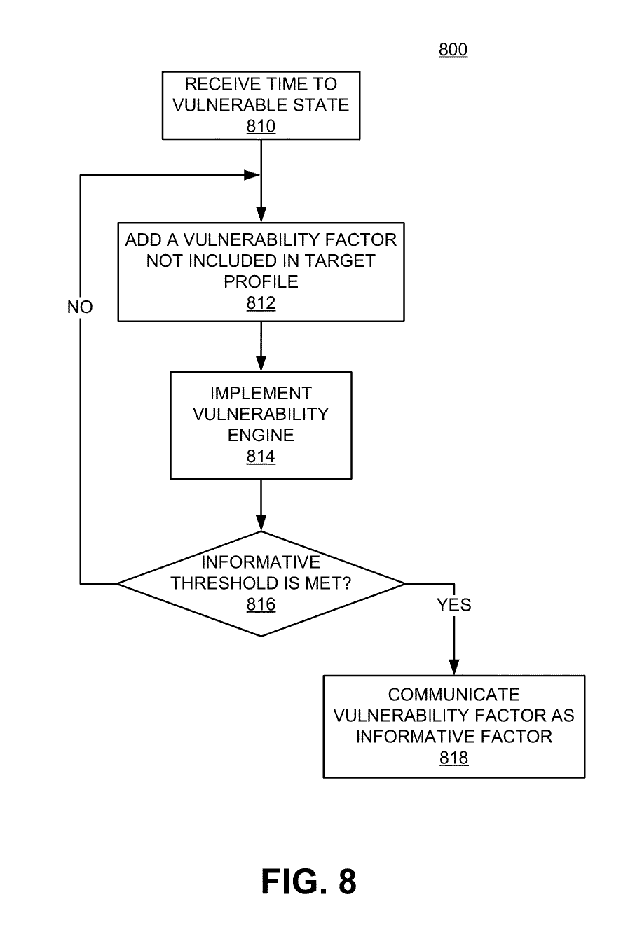

FIG. 8 illustrates a flowchart of a method for determining informative factors in an application, according to various embodiments. According to various embodiments, method 800 may correspond to operation 524 in FIG. 5. The method 800 may access the time to vulnerable state at operation 810. The vulnerability engine described elsewhere herein may be part of the method 700, according to various embodiments. Accessed time to vulnerable state 810 may be a time to vulnerable state, according to various embodiments. Access of time to vulnerable state may occur before an output of time to vulnerable state is displayed.

At operation 812, the vulnerability engine may select a vulnerability factor to be added, which was not included in target profile. There may exist a list of possible vulnerability factors from which included and not included vulnerability factors can be determined. The vulnerability factor selected to be added may be selected for various reasons. For instance, the vulnerability factor selected may be generally considered to be influential on output. The vulnerability factor selected may also be selected at random from the factors not currently included, according to various embodiments. A random selection of a vulnerability factor from remaining vulnerability factors may be done by various means of randomization or may simply be selected from a preset ordered list of vulnerability factors, excluding the vulnerability factors already answered. For example, some vulnerability factors may generally have a more substantial effect on times to vulnerable state, or reduce associated ranges of uncertainty, and may therefore be chosen first. Whether the selected vulnerability is selected in particular or at random, the vulnerability factor may be selected to avoid repeating before all vulnerability factors are each selected once, potentially avoiding redundancy, according to various embodiments.

At operation 814, the vulnerability engine may implement the newly-included vulnerability factor. The vulnerability engine may analyze the previous vulnerability factors values, in addition to the value of the newly-included vulnerability factor 812 to calculate a new output estimated time to vulnerable state. The vulnerability engine may implement various probabilistic or dynamic operations to analyze the previous vulnerability factors as well as the newly-included vulnerability factor.

At operation 816, the vulnerability engine may analyze the output of the new value as calculated by the vulnerability engine to determine if an informative threshold is met. The informative threshold may be set by various means. For example, a user may determine that a particular threshold is a critical level. A database or other computer program may also set the informative threshold, according to various embodiments. The database or other computer program may be particular to the purposes of the user, who may be a care worker, according to various embodiments.

At 818, if the vulnerability engine determines that the informative threshold is met, then the vulnerability factor is communicated as an informative factor. The communication may be accomplished through a dashboard, according to various embodiments. Otherwise, if informative threshold is not met, then another vulnerability factor not included in profile may be selected and added at operation 812 and the process may be repeated for that vulnerability factor.

For example, a target profile may indicate that the client of a care worker has a time to vulnerable state of sixty days based on lack of shelter. The vulnerability engine may select a vulnerability factor, according to various embodiments. For example, a selected vulnerability factor may include the client's credit or housing history. If the lack of shelter vulnerability factor is found to be a relatively short time to vulnerable state, (for lack of shelter) then an informative factor may indicate that a client's credit or housing history may potentially have a substantial impact if the client is found to have a history of eviction. The care worker then, in accordance with the informative factor determined, may direct questions to the client regarding the client's credit or housing history, according to various embodiments. If the informative threshold is not met, the vulnerability engine may restart the process with yet another added vulnerability factor at operation 812, according to various embodiments

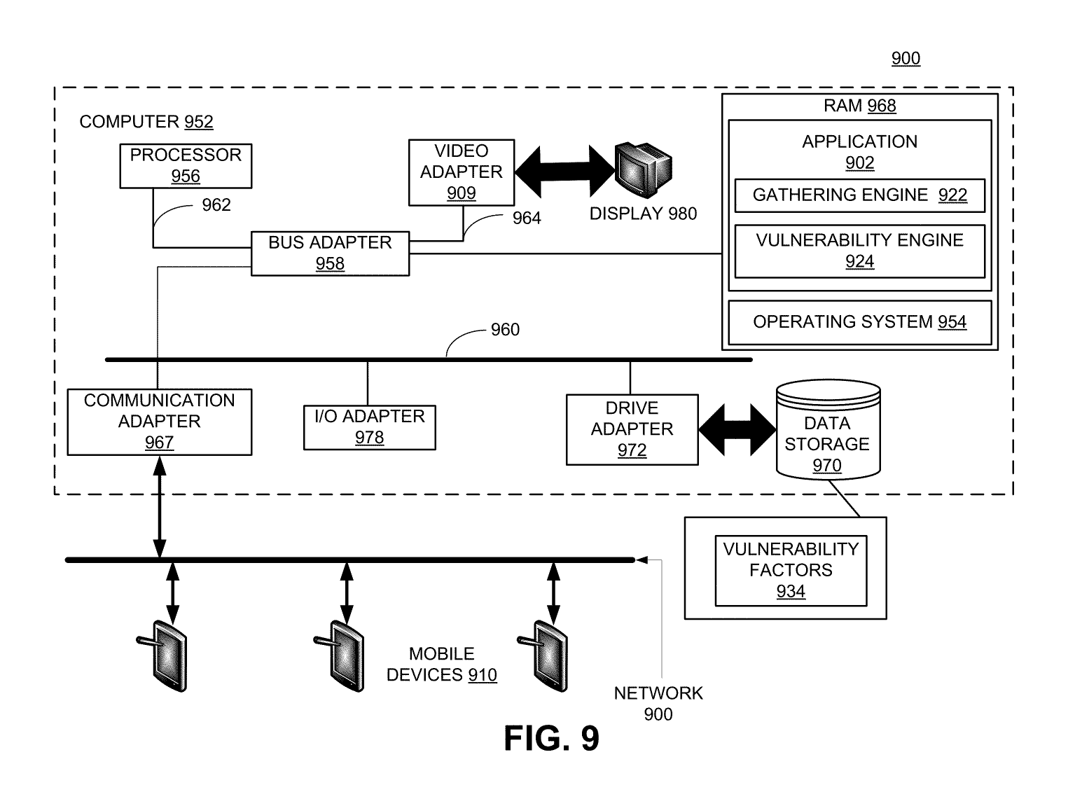

FIG. 9 illustrates a block diagram of automated computing machinery, according to various embodiments. The computing machinery may include example computer 952 useful in performing aspects of the disclosure, according to various embodiments. The computer 952 of FIG. 9 includes at least one computer processor 956 or ‘CPU’ as well as random access memory 968 (‘RAM’) which is connected through bus adapter 958 to processor 956 and to other components of the computer 952.

The RAM 968 may include an application 902. The application 902 may determine estimated time to vulnerable state. The application 902 may have a gathering engine 922 and a vulnerability engine 924. The gathering engine 922 may receive data regarding one or more vulnerability factors 934 regarding a target individual and determine the interdependence between various inputs and the effect on the target individual's time to vulnerable state. The vulnerability factors 934 may be populated into the data storage 970. The vulnerability engine 924 may access the interdependence values between vulnerability factors for each target individual and weight different vulnerability factor in order to produce an estimated time to vulnerable state using probabilistic or dynamic operations.

The RAM 968 may include an operating system 954. Operating systems useful for record filtering according to embodiments of the present disclosure include UNIX®, Linux®, Microsoft XP™, AIX®, IBM's i5/OS™, and others. The operating system 954 are shown in RAM (968), but many components of such software typically are stored in non-volatile memory also, such as, for example, on a disk drive 970.

The computer 952 may also include disk drive adapter 972 coupled through expansion bus 960 and bus adapter 958 to processor 956 and other components of the computer 952. Disk drive adapter 972 connects non-volatile data storage to the computer 952 in the form of disk drive 970. Disk drive adapters useful in computers include Integrated Drive Electronics (‘IDE’) adapters, Small Computer System Interface (‘SCSI’) adapters, Serial AT Attachment (‘SATA’), and others. Non-volatile computer memory also may be implemented for as an optical disc drive, electrically erasable programmable read-only memory (so-called ‘EEPROM’ or ‘Flash’ memory), RAM drives, and so on.

The data storage 970 may include one or more storage devices in a tiered or non-tiered configuration. The data storage 970 may include one or more vulnerability inputs that are received by the application and stored for later use by the application 902 through vulnerability engine 924.

The example computer 952 includes one or more input/output (‘I/0’) adapters 978. I/O adapters implement user-oriented input/output through, for example, software drivers and computer hardware for controlling output to display devices such as computer display screens, as well as user input from user input devices 981 such as keyboards, mice, styli, or touchscreens, according to various embodiments. The example computer 952 includes a video adapter 909, which is an example of an I/O adapter specially designed for graphic output to a display device 980 such as a display screen or computer monitor. Video adapter 909 is connected to processor 956 through a high speed video bus 964, bus adapter 958, and the front side bus 962, which is also a high speed bus.

The example computer 952 includes a communications adapter 967 for data communications with other computers 910, for example, mobile devices, and for data communications with a data communications network 900. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters include modems for wired dial-up communications, Ethernet (IEEE 802.3) adapters for wired data communications network communications, and IEEE 802.77 adapters for wireless data communications network communications.

The descriptions of the various embodiments of the present disclosure have been presented for purposes of illustration, but are not intended to be exhaustive or limited to the embodiments disclosed. Many modifications and variations will be apparent to those of skill in the art without departing from the scope and spirit of the described embodiments. The terminology used herein was chosen to best explain the principles of the embodiments, the practical application or technical improvement over technologies found in the marketplace, or to enable others of skill in the art to understand the embodiments disclosed herein.

The present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that may retain and store instructions for use by an instruction execution device. The computer readable storage medium may be, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disc (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the ‘C’ programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

While the present disclosure is not necessarily limited to such applications, various aspects of the disclosure may be appreciated through a discussion of various examples using this context.

The descriptions of the various embodiments of the present disclosure have been presented for purposes of illustration, but are not intended to be exhaustive or limited to the embodiments disclosed. Many modifications and variations will be apparent to those of skill in the art without departing from the scope and spirit of the described embodiments. The terminology used herein was chosen to explain the principles of the embodiments, the practical application or technical improvement over technologies found in the marketplace, or to enable others of skill in the art to understand the embodiments disclosed herein.

What is claimed is:

1. A method, for a vulnerability analysis application, comprising:
assembling a profile from a first vulnerability factor grouping from plurality of vulnerability factors with each vulnerability factor having a vulnerability factor value;
performing a probabilistic operation on the vulnerability factor values from the first vulnerability factor grouping to obtain a first probabilistic result;
performing a dynamic operation on the first probabilistic result from the probabilistic operation to obtain a first time to vulnerable state for the profile; and
displaying the first time to vulnerable state for the profile.

2. The method of claim 1, wherein the performing the dynamic operation on the first probabilistic result includes:
obtaining a time to recovery estimate for the profile.

3. The method of claim 1, wherein the performing the dynamic operation includes:
implementing a Markov chain model.

4. The method of claim 1, wherein the performing the probabilistic operation includes:
implementing a Bayesian network model.

5. The method of claim 1, further comprising:
determining whether a time to vulnerable state threshold is met for the first time to vulnerable state.

6. The method of claim 5, further comprising:
determining a contributing factor for the profile in response to the time to vulnerable state threshold being met for the first time to vulnerable state; and
displaying the contributing factor for the profile.

7. The method of claim 6, wherein determining the contributing factor includes:
selecting a first vulnerability factor from the first vulnerability factor grouping;
changing a first vulnerability factor value of the first vulnerability factor;
performing the probabilistic operation on the first vulnerability factor value to obtain a second probabilistic result;
performing the dynamic operation on the second probabilistic result from the probabilistic operation to obtain a second time to vulnerable state for the profile;
determining whether the time to vulnerable state meets a contributory threshold; and
selecting the first vulnerability factor as the contributing factor in response to the contributory threshold being met.

8. The method of claim 7, further comprising:
selecting a second vulnerability factor from the first vulnerability factor grouping;
changing a second vulnerability factor value of the second vulnerability factor;
performing the probabilistic operation on the second vulnerability factor value to obtain a third probabilistic result; and
performing the dynamic operation on the third probabilistic result from the probabilistic operation to obtain a third time to vulnerable state for the profile.

9. The method of claim 1, further comprising:
determining one or more informative factors for the profile; and
displaying the one or more informative factors for the profile.

10. The method of claim 9, wherein determining the one or more informative factors includes:
creating a second vulnerability factor grouping from the first vulnerability factor grouping, wherein at least one vulnerability factor from the second vulnerability factor grouping is different than the first vulnerability factor grouping;
performing the probabilistic operation on the second vulnerability factor grouping to obtain a fourth probabilistic result;
performing the dynamic operation on the fourth probabilistic result from the probabilistic operation to obtain a fourth time to vulnerable state for the profile;
determining whether an informative threshold is met; and
selecting the at least one vulnerability factor from the second vulnerability factor grouping as the informative factor.

11. The method of claim 10, wherein selecting the at least one vulnerability factor from the second vulnerability factor grouping as the informative factor includes:
communicating the informative factor to a user, receiving a value for the informative factor.

12. A system for analyzing behavior, comprising:
a plurality of computer processor circuits that are configured to host a vulnerability analysis application that is configured to:
assemble a profile from a first vulnerability factor grouping from plurality of vulnerability factors with each vulnerability factor having a vulnerability factor value;
perform a probabilistic operation on the vulnerability factor values from the first vulnerability factor grouping to obtain a first probabilistic result;
perform a dynamic operation on the first probabilistic result from the probabilistic operation to obtain a first time to vulnerable state for the profile; and
display the first time to vulnerable state for the profile.

13. The system from claim 12, wherein the plurality of computer processor circuits are configured to:
assemble the profile by:
receiving the first vulnerability factor grouping, transmitted from an Internet web search for general information regarding an individual.

14. The system from claim 13, further comprising:
utilizing an Internet web search selected from sources including: Internet web search engines, social networking websites, personal websites, professional websites, and public record databases.

15. The system from claim 12, wherein the computer processor circuits are configured to assemble the profile by:
assembling the first vulnerability factor grouping from the plurality of vulnerability factors, wherein the first vulnerability factor grouping is assembled from partial or incomplete data.

16. A computer program product for vulnerability analysis comprising: a computer readable storage device having a computer readable program stored therein, wherein the computer readable program, when executed on a computing device, causes the computing device to:
assemble a profile from a first vulnerability factor grouping from plurality of vulnerability factors with each vulnerability factor having a vulnerability factor value;
perform a probabilistic operation on the vulnerability factor values from the first vulnerability factor grouping to obtain a first probabilistic result;
perform a dynamic operation on the first probabilistic result from the probabilistic operation to obtain a first time to vulnerable state for the profile; and
display the first time to vulnerable state for the profile.

17. The computer program product of claim 16, wherein the computer readable program causes the computing device to display the first time to vulnerable state for the profile by:
determining whether a target individual associated with the profile is identified as a High-Cost, High-Need individual.

18. The computer program product of claim 16, wherein the High-Cost, High-Need individual receives a different processing path.

19. The computer program product of claim 16, wherein display the first time to vulnerable state for the profile is displayed on a dashboard in terms of a single metric.

20. The computer program product of claim 19, wherein the single metric is measured as estimated time to vulnerable state
